(19) United States
(12) Patent Application Publication
(10) Pub. No.: US 2006/0291858 A1
(43) Pub. Date: Dec. 28, 2006

(54) Bi-directional compound-WDM fiberoptic system architecture with redundancy protection for transmission of data, voice and video signals

(76) Inventors: Xin Simon Lou, Monterey Park, CA (US); Leo Kha, Diamond Bar, CA (US)

Correspondence Address: EMCORE CORPORATION, 1600 EUBANK BLVD, S.E., ALBUQUERQUE, NM, 87123, US

(21) Appl. No.: 11/045,914

(22) Filed: Jan. 31, 2005

(51) Int. Cl. H04B 10/20

(52) U.S. Cl. 398/58

(57) ABSTRACT

An optical architecture and network is described that includes first and second transceivers coupled by an optical fiber. The first and second transceivers concurrently transmit and receive a plurality of optical signals that propagate in a first direction and at least one optical signal propagating in a second, opposite direction through the optical fiber. The network includes the first transceiver that uses a first means for combining the plurality of optical signals and a second means for transmitting the combined plurality of optical signals into the fiber in the first direction and for intercepting and redirecting the optical signal propagating from the fiber in the second, opposite direction. The network further includes the second transceiver that uses a third means for passing the optical signal propagating into the fiber in the second opposite direction and for redirecting the optical signals propagating from the fiber in the first direction. The second transceiver further includes fourth means in a path of the redirected optical signals for passing a first optical signal of the plurality of redirected optical signals and for further redirecting any remaining optical signals and a fifth means for passing a second optical signal of the remaining further redirected optical signals.

### FIELD OF THE INVENTION

The field of the invention relates to fiber optic communication system/architecture and more particularly to coarse wavelength division multiplexing (CWDM) systems and networks.

### BACKGROUND OF THE INVENTION

Optical signals transmitted over optical fibers have a clear capacity advantage over copper conductors. While copper conductors have an information transmission capacity in the high megaHertz to low gigaHerz range, optical transmission systems operate in the high gigaHertz or even in the teraHertz range.

Optical fibers composed of silica generally have three useful transmission bands. The three bands are located at optical wavelengths of about 850, 1310 and 1550 nanometers. The location of the bands are partly a function of the characteristics of the fiber itself (e.g., optical absorption and dispersion within the fiber at different wavelengths) and partly a function of the interface devices (e.g., lasers and light emitting diodes (LEDs), etc.). As a result of these and other factors, the 1310 nm and 1550 nm bands are the most generally used.

In use, a number of different optical carriers of different center frequencies may be modulated with a respective information signal and combined for transmission through a single optical fiber. When the wavelength spacing is from 1.6 nm to 25 nm, the process is referred to as CDWM. When optical carriers in the 1310 nm and 1550 nm wavelength range are combined, the process may be referred to as wavelength division multiplexing (WDM).

While the use of multiple carriers has simplified the exchange of optical signals, the process of recovering communication signals from the individual optical carriers is still a limiting factor in the use of CDWM and WMD. For example, one prior art reference (i.e., U.S. Pat. No. 5,969,836 to Foltzer) has described the use of graded-index fiber lens optical multiplexers to combine a pair of optical carriers or to separate one optical carrier from one other optical carrier. Another reference (i.e., U.S. Pat. No. 6,542,306 to Goodman) describes a bi-directional device that may be used to combine a number of carriers for transmission through a single fiber or that separates a number of carriers that are received from a single fiber.

While the prior devices are effective to a certain extent, they are limited in their ability to simultaneously process bi-directional signals. In addition, new initiatives such as fiber to the user (FTTU) has placed new demands upon the optical signal processing requirements of telecommunications providers.

In this regard, the FTTH initiative has its basis in the concept that voice, data and video applications in the home can be serviced through a single optical fiber. Once optical fibers have been provided in a residential setting, it has been proposed that Internet/TV/telephone service may be provided through a process called triplexing. Because of the importance of optical communication systems, a need exists for optical architectures and devices that are more flexible and that can handle any number of signals propagating in any direction.

### SUMMARY

An optical architecture and network is described that includes first and second transceivers coupled by an optical fiber. The first and second transceivers concurrently transmit and receive a plurality of optical signals that propagate in a first direction and at least one optical signal propagating in a second, opposite direction through the optical fiber. The network includes the first transceiver that uses a first means for combining the plurality of optical signals and a second means for transmitting the combined plurality of optical signals into the fiber in the first direction and for intercepting and redirecting the optical signal propagating from the fiber in the second, opposite direction. The network further includes the second transceiver that uses a third means for passing the optical signal propagating into the fiber in the second opposite direction and for redirecting the optical signals propagating from the fiber in the first direction. The second transceiver further includes fourth means in a path of the redirected optical signals for passing a first optical signal of the plurality of redirected optical signals and for further redirecting any remaining optical signals and a fifth means for passing a second optical signal of the remaining further redirected optical signals.

### BRIEF DESCRIPTION OF THE DRAWINGS

FIG. 1 is a block diagram of an optical architecture and network under an illustrated embodiment of the invention;

FIGS. 2a-b depicts a multiplexing and demultiplexing process that may be used by the system of FIG. 1;

FIGS. 3a-b depicts a simplified multiplexing and demultiplexing process that may be used by the system of FIG. 1; and

FIG. 4 depicts a simplified optical network that may be used by the system of FIG. 1;

### DETAILED DESCRIPTION OF AN ILLUSTRATED EMBODIMENT

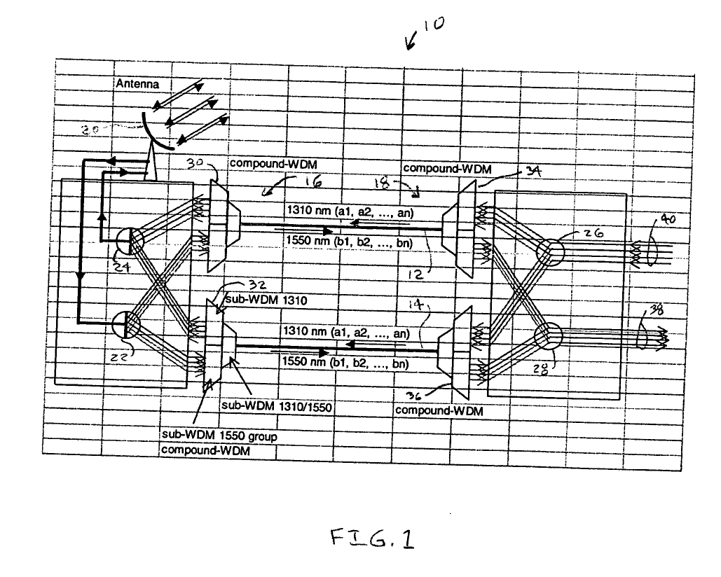

FIG. 1 is a simplified block diagram of an optical communication architecture and system 10 under an illustrated embodiment of the invention shown generally in a context of use. As shown, the communication system 10 may include first and second transceivers 16, 18 that exchange optical signals through one more optical fibers 12, 14.

The system 10 may be used in any of a number of different contexts that allow for the rapid exchange of very large amounts of information. For example, the system 10 shown in FIG. 1 may be used in support of satellite communication (Satcom) or WI-FI communication systems.

In the system 10 of FIG. 1, radio frequency (rf) signals received from the antenna 20 may be used to modulate a number of lasers 22 in a first transceiver 16 to produce a number of respective modulated optical signals that may be multiplexed within multiplexers 30, 32 for transmission to the opposing transceiver 18 in a first (downstream) direction over fibers 12, 14. The modulated optical signals from the first transceiver 16 may be demultiplexed within a set of demultplexers 34, 36 of the opposing transceiver 18 and any communication signals used to modulate the optical carriers may be detected within photodiodes 28. The detected communication signals may be distributed over a local optical network 38.

Similarly, communication signals received from the local optical network 40 by the opposing transceiver 18 may be used to modulate respective optical carriers within lasers 26. The modulated optical carriers may be multiplexed within multiplexers 34, 36 for transmission back the first transceiver 16 in a second (upstream) direction over fibers 12, 14. Within the first transceiver 16, the modulated optical signals from the opposing transceiver 18 are similarly demultiplexed within a set of demultiplexers 30, 32 of the first transceiver 16 to isolate the individual modulated carriers before the modulated carriers are detected within respective diodes 24.

The lasers 22 of the first receiver may provide a set of modulated carrier frequencies (e.g., b1, b2 . . . , bn) spaced around 1550 nm with an appropriate channel frequency spacing (e.g., 60 nm). Similarly, the second receiver may provide a set of modulated carrier frequencies (e.g., a1, a2 . . . an) spaced around 1310 nm with an appropriate channel frequency spacing (e.g., 60 nm). The use of a relatively large channel spacing may be referred to as compound WDM.

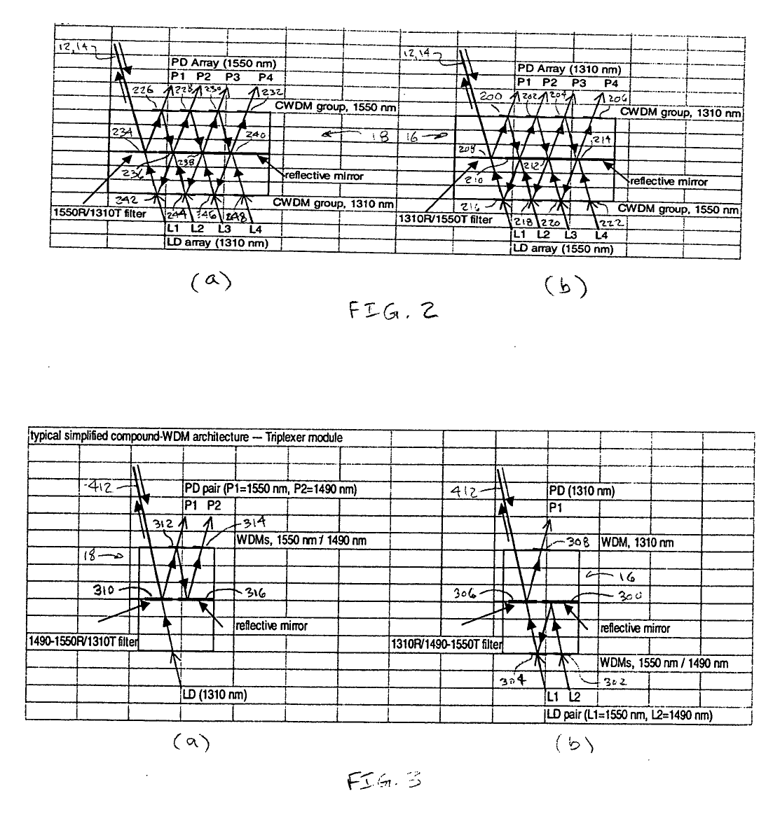

FIG. 2 is a simplified schematic of the operation of the multiplexers 30, 32, 34, 36. FIG. 2a depict multiplexing and demultiplexing within multiplexers 34, 36 of the second transceiver 18 in the case of four optical channels with four optical carriers and FIG. 2b depicts multiplexing and demultiplexing with the first transceiver 16 in the case of four optical channels with four optical carriers.

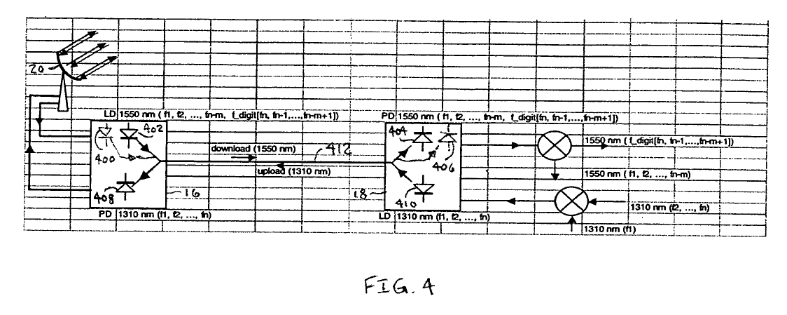

FIG. 3 is a further simplified example FIG. 1. In FIG. 3, first and second modulated carriers L1, L2 (i.e., L1=1550 nm and L2=1490 nm) are combined and transmitted in a downstream direction from the first transceiver 16 to the second transceiver 18 while a single modulated carrier LD (i.e., LD=1310 nm) is transferred in an upstream direction from the second transceiver 18 to the first transceiver 16. FIG. 4 shows the example of FIG. 3 from the rf perspective.

Turning first to FIGS. 3 and 4, an explanation will first be offered of operation of the transceiver 16 in the context of three carriers L1, L2, LD. As may be noted, in FIG. 4 the group of lasers 22 within the first transceiver 16 in FIG. 1 have been replaced by two downstream lasers 400, 402 and the photodetectors 24 of FIG. 1 has been replaced by a single photodetector 408. Similarly, the group of photodetectors 28 in the second receiver 18 of FIG. 1 have been replaced with two photodetectors 404, 406 in FIG. 4 and the group of lasers 26 in the second receiver 18 of FIG. 1 has been replaced by a single laser 410 in FIG. 4. For simplicity, the first and second transceivers 16, 18 are shown connected through use of a single optical fiber 412 in FIG. 4.

As may be noted from FIG. 4, first and second information signals f1, f2 modulate laser diodes 400, 402 to generate a pair of modulated carriers L1, L2. As shown in FIG. 3b, modulated carriers L1 and L2 enter the optical portion of the transceiver 16 and are combined. In this regard, it may be noted that modulated carriers L1 and L2 enter the transceiver optics through optical devices 302, 304.

Optical 81 devices 302, 304 may be wavelength selective reflectors (directional isolators) that are substantially transparent (transmissive) to a desired optical frequency and reflective to other optical frequencies. Because of the fact that the devices 302, 304 may reflect some frequencies and transmit others, the devices 302, 304 may be referred to as filters even though they also operate as a lens for transmission of optical signals.

The devices 302, 304 may constructed as linear variable filters that have a controlled non-uniformity of layer thickness from one end of the filter to the other end to selectively transmit light in a linearly variable manner along the length thereof. The wavelength selective filter can also be a monolithic substrate having a bandpass filter formed thereon with a passband wavelength that is dependent upon an angle of incidence of a light beam (e.g., a Bragg filter).

The wavelength selective filter 302, 304 may also be constructed in the form of a lens with one or more interference filters. Such filters can be made by depositing a series of alternating thin-film layers with different refractive indices, such as alternating layers of materials with a high and low refractive index. The composite structure provides a wavelength selective filter that depends upon the thickness of the layers, their refractive indices, the wavelength of light and the angle at which the light strikes a thin film coating.

In the case of FIG. 3b the first device 302 may be a wavelength selective notch filter with a passband centered on 1490 nm. The passband may have a width determined by the carrier frequency (e.g., 60 nm, plus guardband). Since the device 302 is centered on 1490 nm, the modulated optical signal L2 passes through the device 302 and is reflected by a mirror 300 to the second optical device 304.

The second optical device 304 may have a passband centered on 1550 nm. Since the second device 304 is centered on 1550 nm, the second modulated optical signal L1 passes through the filter 304 as if it were transparent.

However, when the first modulated carrier L2 strikes the wavelength selective filter 304, the carrier L2 is reflected. The transmission of the second carrier L1 and reflection of the first carrier L2 effectively results in a linear combination of the two carriers L1 and L2.

The combined carriers L1 and L2 then impinge upon another wavelength selective optical filter 306. In this case, the filter 306 may have a wider passband including the wavelengths of from 1490 to 1550 nm.

While the combined downstream carriers L1 and L2 pass through the lens/filter 306, the upstream carrier LD proceeding in the opposite direction is reflected since it is outside of the passband of the filter 306. In this case, the modulated carrier LD is redirected by the filter 306 to lens/filter 308. In this case, the lens/filter 308 may be constructed with a passband centered at 1310 nm which allows the carrier LD to pass through the optical filter 308 and be detected in a photodiode P1 (408 in FIG. 4). Once detected within the photodiode 408, the information signal may be transferred to a distal user through the antenna 20.

In the upstream direction, the combined carriers L1, L2 may be transferred to the second receiver 18 through the optical fiber 412. Within the optics of the second transceiver 18 (FIG. 3a), the combined carriers L1, L2 impinge upon optical device 310. Optical device 310 may also be a wavelength selective reflector centered on 1310 nm.

Since lens/filter 310 has a passband centered on 1310 nm, the combined carriers L1 and L2 are reflected and redirected to optical device 312. In this case, optical device 312 may be a wavelength selective reflector (lens/filter) centered on 1550 nm.

Since optical device 312 has a passband centered on 1550 nm, the first modulated carrier L1 passes through the optical device 312 and the second modulated carrier L2 is reflected and redirected to mirror 316. After passing through the optical device 312, the first modulated carrier L1 may be detected in a photodiode 404, as shown in FIG. 4 for use in a set-top box or the first modulated carrier L1 may be distributed through a local optical system 38, as shown in FIG. 1.

The second optical carrier L2 may be reflected and redirected by the mirror 316 of FIG. 3a into a further optical device 314. Optical device 314 may be another wavelength selective filter (lens/filter) or simply an optical filter centered at 1490 nm. As above, the second modulated carrier L2 may be detected in photodiode 406 of FIG. 4 or distributed under an optical format in the local optical system 38 of FIG. 1.

The upstream information signal f1 may be used to create the upstream modulated carrier LD centered at 1310 nm in laser diode 410. Since the optical device 310 has a passband centered on 1310 nm, the upstream modulated carrier LD passes through the optical device 306 without change and is directed into the fiber 412.

Returning now to FIG. 1, it can now be seen that FIG. 1 shows the more general case having some number of downstream optical carriers that is greater than one and some other number (that could be the same or larger) of upstream carriers. In this case, lasers 22 generate a number of modulated downstream carriers L1, L2, L3, L4. Modulated carrier L1 may be centered at 1430 nm, L2 at 1490 nm, L3 at 1550 nm and L3 at 1610 nm. Optical devices 216, 218, 220, 220 within the first transceiver 16 may be wavelength selective reflectors centered at 1430, 1490, 1550, 1610 nm, respectively. Optical devices 210, 212 and 214 may be reflective on both sides at all frequencies. Optical device 208 may be a wavelength selective reflector that has a passband from 1430 to 1610 nm.

In operation, downstream carriers L1, L2, L3, L4 are combined as described above by incremental addition, one-at-a-time with the carriers propagating along a zig-zag path defined by devices 222, 214, 220, 212, 218, 210, 216. Carrier L4 is combined with L3 in device 220, carriers L4, L3 and L2 are combined in device 218 and carriers L4, L3, L2 and L1 are combined in device 216. The combined carriers L1, L2, L3, L4 are transmitted into the fiber 12, 14 through device 208.

Similarly, upstream carriers L1, L2, L3, L4 may be generated within lasers 26. Carrier L1 may have a frequency of 1190 nm, L2 a frequency of 1250 nm, L3 a frequency of 1310 nm and L4 a frequency of 1370 nm.

Optical devices 242, 244, 246, 248 within the second transceiver 18 may be wavelength selective reflectors centered at 1190, 1250, 1310, 1370 nm, respectively. Optical devices 236, 238 and 240 may be reflective on both sides at all frequencies. Optical device 234 may be a wavelength selective reflector that has a passband from 1190 to 1370 nm.

In operation, upstream carriers L1, L2, L3, L4 are combined as described above by incremental addition, one-at-a-time with the carriers propagating along a zig-zag path defined by devices 248, 240, 246, 238, 244, 236, 242. Carrier L4 is combined with L3 in device 246, carriers L4, L3 and L2 are combined in device 244 and carriers L4, L3, L2 and L1 are combined in device 242. The combined carriers L1, L2, L3, L4 are transmitted into the fiber 12, 14 through device 234.

Demultiplexing of the downstream carriers L1, L2, L3, L4 within the second transceiver 18 may also occur as described above for the three carrier example. In FIG. 2b, devices 200, 202, 204, 206 may be wavelength selective filters centered at 1190 nm, 1250 nm, 1310 and 1370 nm, respectively. Demultiplexing may occur along a zig-zag path defined by the sequence of devices 208, 200, 210, 202, 212, 204, 214, 206. The carrier L1 at 1190 nm may be isolated from the other carriers L2, L3, L4 by device 200. Any remaining carriers may be redirected by device 200 to device 210 which in turn redirects the remaining carriers to device 202 which isolates carrier L2 from carriers L3 and L4. Similarly, device 204 isolates carrier L3 from L4 and device 206 isolates carrier L4 from any remaining optical signals present. Demultiplexing of the upstream carriers occurs in a substantially similar manner within the second transceiver 16.

A specific embodiment of an optical network has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. An optical architecture that includes first and second transceivers coupled by an optical fiber, said first and second transceivers concurrently transmitting and receiving a plurality of optical signals that propagate in a first direction and at least one optical signal propagating in a second, opposite direction through the optical fiber, such network comprising:
the first transceiver that uses a first means for combining the plurality of optical signals and a second means for transmitting the combined plurality of optical signals into the fiber in the first direction and for intercepting and redirecting the optical signal propagating from the fiber in the second, opposite direction; and
the second transceiver that uses a third means for passing the optical signal propagating into the fiber in the second opposite direction and for redirecting the optical signals propagating from the fiber in the first direction, said second transceiver further comprising fourth means in a path of the redirected optical signals for passing a first optical signal of the plurality of redirected optical signals and for further redirecting any remaining optical signals and a fifth means for passing a second optical signal of the remaining further redirected optical signals.

2. The optical architecture of claim 1 wherein the at least one optical signal propagating in the second, opposite direction further comprise a plurality of optical signals.

3. The optical architecture of claim 2 further comprising means within the second transceiver for combining the plurality of optical signals that are propagated in the second, opposite direction.

4. The optical architecture of claim 3 further comprising means within the second transceiver for transmitting the combined plurality of optical signals into the fiber in the second, opposite direction.

5. The optical architecture of claim 3 wherein the first means intercepts and redirects the plurality of optical signals propagating in the second, opposite direction.

6. The optical architecture of claim 5 further comprising means within the first transceiver located in a path of the redirected plurality of optical signals propagating in the second, opposite direction for passing an optical signal and for redirecting any remaining optical signals.

7. The optical architecture of claim 6 further comprising means for passing a remaining optical signal of the remaining optical signals propagated in the second, opposite direction.

8. The optical architecture of claim 1 wherein the first means for combining the plurality of optical signals further comprises a reflective surface.

9. The optical architecture of claim 1 wherein the second means for transmitting the combined plurality of optical signals into the fiber in the first direction and for intercepting and redirecting the optical signal propagating from the fiber in the second, opposite direction further comprises an optical filter that passes the combined plurality of optical signals and reflects the optical signal.

10. The optical architecture of claim 9 wherein the optical filter further comprises a Bragg filter.

11. The optical architecture of claim 9 wherein the optical filter further comprises a wavelength selective reflector made by depositing a series of alternating thin film layers with different refractive indices.

12. The optical architecture of claim 1 wherein the third means for passing the optical signal propagating into the fiber in the second opposite direction and for redirecting the optical signals propagating from the fiber in the first direction further comprises an optical filter that passes the optical signal and reflects the optical signals.

13. The optical architecture of claim 1 wherein the fourth means in a path of the redirected optical signals for passing a first optical signal of the plurality of redirected optical signals and for further redirecting any remaining optical signals further comprises an optical filter that passes the optical signal and reflects the remaining optical signals.

14. The optical architecture of claim 1 wherein the fifth means for passing a second optical signal of the remaining optical signals further comprises an optical filter that passes the optical signal and reflects any remaining optical signals.

15. An optical architecture that includes first and second transceivers coupled by an optical fiber, said first and second transceivers concurrently transmitting and receiving a plurality of downstream optical signals and at least one upstream optical signal through the single optical fiber, such network comprising:
the first transceiver that uses a first reflective surface to combine the plurality of downstream optical signals and an optical filter that passes the combined plurality of downstream optical signals for transmission through the fiber and redirects the upstream signal from the fiber; and
the second transceiver that uses a first optical filter that passes the upstream optical signal for transmission through the fiber and redirects the downstream optical signals from the fiber, said second transceiver further comprising a plurality of optical filters in a path of the redirected downstream optical signals where a first optical filter of the plurality of optical filters passes a first optical signal of the plurality of redirected downstream optical signals and further redirects any remaining downstream optical signals and a second optical filter of the plurality of optical filters that passes a second optical signal of the remaining downstream optical signals.

16. The optical architecture as in claim 15 wherein the at least one upstream optical signal further comprises a plurality of upstream optical signals.

17. The optical architecture as in claim 15 wherein the optical filter of the first transceiver that passes the combined plurality of downstream optical signals for transmission through the fiber and redirects the upstream signal from the fiber further comprises a wavelength selective reflector.

18. The optical architecture as in claim 15 wherein the first optical filter that passes the upstream optical signal for transmission through the fiber and redirects the downstream optical signals from the fiber further comprises a wavelength selective reflector.

19. An optical architecture that includes first and second transceivers coupled by an optical fiber, said first and second transceivers concurrently transmitting and receiving a plurality of optical signals that propagate in a first direction from the first transceiver to the second transceiver and a plurality of optical signals propagating in a second, opposite direction from the second transceiver to the first transceiver through the optical fiber, such network comprising:
the first transceiver that further comprises a directional isolator that optically separates the combined plurality of optical signals propagating towards the first transceiver from the plurality of optical signals propagating towards the second transceiver, a multiplexer that optically combines the plurality of optical signals to be transmitted towards the second transceiver through the directional isolator and a demultiplexer that optically demultiplexes the combined optical signals received through the directional isolator of the first transceiver from the second transceiver; and
the second transceiver that further comprises a directional isolator that optically separates the combined plurality of optical signals propagating towards the second transceiver from the plurality of optical signals propagating towards the first transceiver, a multiplexer that optically combines the plurality of optical signals to be transmitted towards the first transceiver through the directional isolator and a demultiplexer that optically demultiplexes the combined optical signals received through the directional isolator of the second transceiver from the first transceiver.

20. The optical architecture of claim 19 wherein the directional isolators of the first and second transceivers further comprises a wavelength selective reflector.
